(19) United States
(12) Patent Application Publication
(10) Pub. No.: US 2010/0071467 A1
(43) Pub. Date: Mar. 25, 2010

(54) INTEGRATED MULTIAXIS MOTION SENSOR

(75) Inventors: STEVE NASIRI, Saratoga, CA (US); JOSEPH SEEGER, MENLO PARK, CA (US); BRUNO BOROVIC, SAN FRANCISCO, CA (US); GOKSEN YARALIOGLU, MOUNTAIN VIEW, CA (US)

Correspondence Address: SAWYER LAW GROUP PC, 2465 E. Bayshore Road, Suite No. 406, PALO ALTO, CA, 94303, US

(73) Assignee: INVENSENSE, SUNNYVALE, CA (US)

(21) Appl. No.: 12/236,757

(22) Filed: Sep. 24, 2008

(51) Int. Cl. G01C 19/56

(52) U.S. Cl. 73/504.12

(57) ABSTRACT

A system and method describes an inertial sensor assembly, the assembly comprises a substrate parallel to the plane, at least one in-plane angular velocity sensor comprising a pair proof masses that are oscillated in anti-phase fashion along an axis normal to the plane. The first in-plane angular velocity sensor further includes a sensing frame responsive to the angular velocity of the substrate around the first axis parallel to the plane and perpendicular to the axis normal to the plane. The assembly also includes at least one out-of-plane angular velocity sensor comprising a pair of proof masses that are oscillated in anti-phase fashion in the plane parallel to the plane. The out-of-plane angular velocity sensor further comprises a sensing frame responsive to the angular velocity of the substrate around the axis normal to the plane.

### CROSS-REFERENCE TO RELATED APPLICATIONS

The present application is related to X-Y AXIS DUAL-MASS TUNING FORK GYROSCOPE WITH VERTICALLY INTEGRATED ELECTRONICS AND WAFER-SCALE HERMETIC PACKAGING, 20080115579/0115579, dated May 22, 2008; and X-Y AXIS DUAL-MASS TUNING FORK GYROSCOPE WITH VERTICALLY INTEGRATED ELECTRONICS AND WAFER-SCALE HERMETIC PACKAGING, filed on May 17, 2005, U.S. Pat. No. 6,892,575 and LOW INERTIA FRAME FOR DETECTING CORIOLIS ACCELERATION, IVS 123, application Ser. No. 12/210,045, filed on Sep. 12, 2008.

### FIELD OF THE INVENTION

The present invention relates to microelectromechanical (MEMS) inertial sensors, and more particularly to the multiple degree-of-freedom (DOF) sensor comprising a plurality of single DOF angular velocity sensors and a plurality of single-DOF linear acceleration sensors accommodated on the same substrate.

### BACKGROUND OF THE INVENTION

A substrate with multiple DOF inertial sensors allows several simultaneous measurements of up to three independent angular velocities and up to three linear accelerations around and along three mutually orthogonal axes. The multi-DOF sensing assembly may comprise any combination of angular velocity sensor responsive to the angular velocity around axis parallel to the plane, an angular velocity sensor responsive to the angular velocity around axis normal to the plane, a linear acceleration sensor responsive to the axis parallel to the plane, and a linear acceleration sensor responsive to the axis normal to the plane.

The in-plane angular velocity sensor of a conventional multi-DOF sensing assembly is designed such that two proof masses are oscillated along the out-of-plane axis in anti-phase fashion.

There are several types of conventional angular velocity sensors. They are described in more detail below. For example, in Cardarelli (U.S. Pat. No. 6,725,719), all inertial instruments are placed on the common substrate which acts as an common gimbal. The gimbal is then driven into oscillations to provide common drive motion for all of the instruments, i.e. inertial sensors. Accordingly, there is a common drive system which does not allow for truly independent means for driving all of the instruments.

Further, in Cardarelli (U.S. Pat. No. 6,859,751), inertial sensors, or instruments, are mounted on the common substrate and are driven independently. The structures are, according to the teaching, formed from the inner and outer member. Inner member is flexibly coupled to the outer member and they are driven together relative to the case, or substrate.

Geen (U.S. Pat. No. 6,848,304), describes a 6 axis inertial sensor. However, it is claimed that three out of six axis are fabricated on the first substrate and the other three axis on the second substrate. Accordingly, this type of sensor is not implemented on a single substrate.

Chen (U.S. Pat. No. 7,168,317), describes a three axis angular velocity sensor. The proof masses for all three axis are always driven parallel to the plane and the sensing of the Coriolis force is different for each axis. This type of sensor also does not allow for a truly independent means for driving all of the assembly instruments.

The present invention relates to microelectromechanical (MEMS) inertial sensors, and more particularly to the multiple degree-of-freedom (DOF) sensor comprising plurality of single DOF angular velocity sensors and single-DOF linear acceleration sensors accommodated on the same substrate. Accordingly, what is needed is an angular velocity sensor that addresses the above-identified issues. The present invention addresses such a need.

### SUMMARY

A system and method describes an inertial sensor assembly, the assembly comprises a substrate parallel to the plane, at least one in-plane angular velocity sensor comprising a pair proof masses that are oscillated in anti-phase fashion along an axis normal to the plane. The first in-plane angular velocity sensor further includes a sensing frame responsive to the angular velocity of the substrate around the first axis parallel to the plane and perpendicular to the axis normal to the plane. The assembly also includes at least one out-of-plane angular velocity sensor comprising a pair of proof masses that are oscillated in anti-phase fashion in the plane parallel to the plane. The out-of-plane angular velocity sensor further comprises a sensing frame responsive to the angular velocity of the substrate around the axis normal to the plane.

### BRIEF DESCRIPTION OF THE DRAWINGS

FIG. 1A shows conventional Y Dual mass tuning fork vibratory gyroscope.

FIG. 1B shows conventional sensing assembly wherein two gyroscopes are rotated 90 deg from each other forming X-Y gyroscope.

FIG. 2 shows conventional Z dual mass tuning fork vibratory gyroscope.

FIG. 3 shows conventional triple axis accelerometer.

FIG. 4A shows sensing assembly for independent detection of three independent angular velocities, in accordance to the present invention.

FIG. 4B shows sensing assembly for independent detection of in-plane and out-of-plane angular velocities, in accordance to the present invention.

FIG. 4C shows another sensing assembly for independent detection of of in-plane and out-of-plane angular velocities, in accordance to the present invention.

FIG. 5 shows sensing assembly for independent detection of three linear accelerations and three independent angular velocities, in accordance to the present invention.

FIG. 6 shows sensing assembly comprising three linear acceleration sensors and out-of-plane angular velocity sensor.

FIG. 7. shows a block diagram of application specific integrated circuitry (ASIC) where several blocks are shared by three angular velocity sensors.

### DETAILED DESCRIPTION OF PREFERRED EMBODIMENTS

The present invention relates to microelectromechanical (MEMS) inertial sensors, and more particularly to the multiple degree-of-freedom (DOF) sensor comprising plurality of single DOF angular velocity sensors and single-DOF linear acceleration sensors accommodated on the same substrate. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Integrating multiple microelectromechanical (MEMS) inertial sensors on a common substrate, for instance, a wafer, yields multiple advantages over having multiple sensors built on several separate substrates subsequently arranged into the multi-DOF sensing assembly. First of all, as the individual sensors are lithographically defined, their input axes are almost perfectly aligned and there is no mounting mismatch between sensors' input axes. The alignment-induced cross-axis sensitivity between different DOFs is basically eliminated for all practical purposes. In addition, individual sensors can be designed so they are packed tightly without waste of available space on the substrate. The substrate may be a single wafer shared by MEMS structures, application specific integrated circuitry (ASIC) and digital interface circuitry. The substrate may comprise two separate wafers bonded together, the first one comprising MEMS structures and the second one comprising integrated circuitry (IC). A high level of integration of the electronic circuitry further contributes to the small size of the overall sensing assembly.

The environmental effects, such as temperature, acts similarly on all integrated MEMS sensors as well as on IC. Therefore, multi-axis sensing assembly can be temperature calibrated in one step. Furthermore, an application specific integrated circuitry (ASIC), the integral part of the sensor assembly, requires less space as many building blocks can be shared between the individual sensors. The size, and the price of the sensing assembly may be substantially reduced. Besides including the ASIC, the sensing assembly may comprise additional intelligence for performing higher level signal processing and application-specific tasks, e.g. motion processor. All individual sensors may share such an on-board processor which substantially minimizes the need for external processing. The low-cost motion-processing intelligence is needed to enable new markets, such as handset or gaming. All in all, the integration of multiple inertial sensors on the same substrate yields an extremely low-cost, easy-to-use, easy-to-implement product that is highly competitive on the market.

Individual sensors sharing a common substrate parallel to the plane may be integrated into a multiaxis sensing assembly in many different ways. Single-substrate multi-axis sensing assembly may comprise plurality of angular in-plane velocity sensors, plurality of out-of-plane angular velocity sensors, plurality of in-plane linear acceleration sensors and plurality of out-of-plane linear acceleration sensors. Depending on application some of the sensors may be omitted. In this disclosure only some typical configurations are described. However, this does not limit the disclosure to described embodiments. To describe the features of the present invention in more detail, refer to the following description in conjunction with the accompanying Figures.

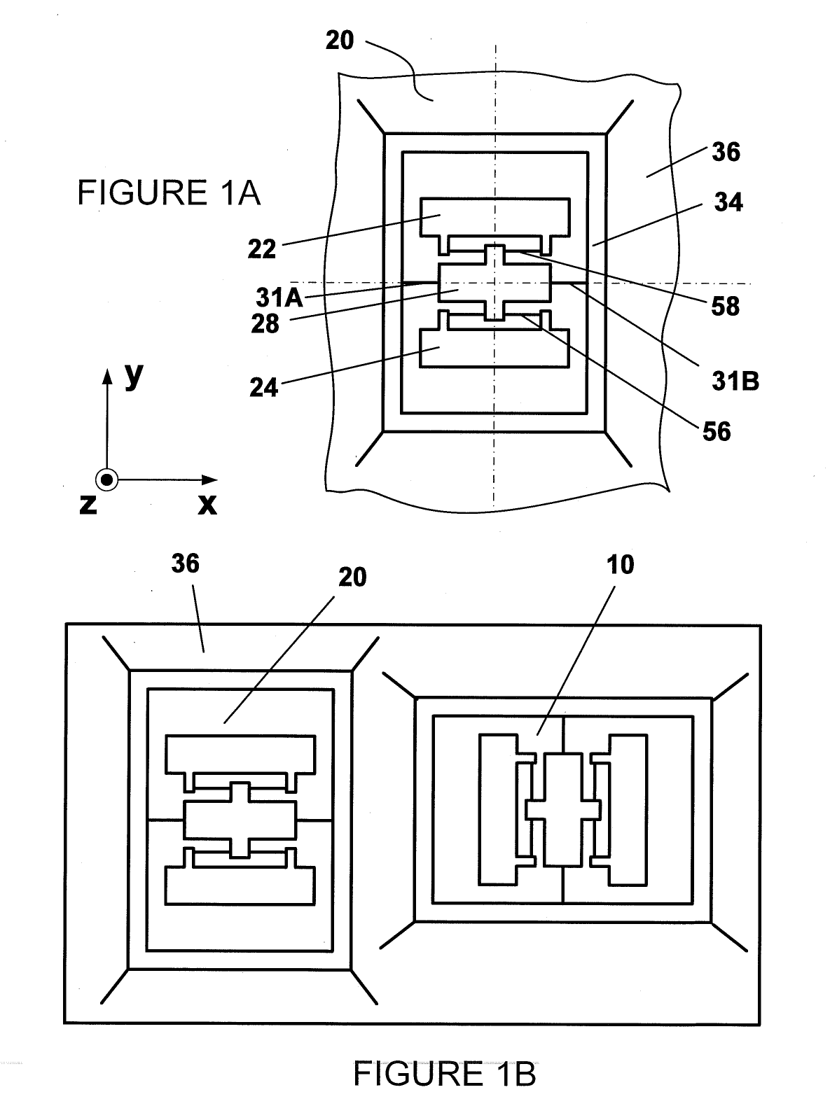

US patent application US 2008/0115579, from May 22, 2008, “X-Y dual-mass tuning fork gyroscope with vertically integrated electronics and wafer-scale hermetic packaging,” discloses a single axis Y gyroscope 20 is shown in FIG. 1A. The gyroscope 20 comprises base 36, sensing frame 34, first proof mass 24, and second proof mass 22. Proof masses 22 and 24, mass 28 and springs 58, 56 and 31A-31B form linkage that allows proof masses to be oscillated out-of-plane in anti-phase fashion. Proof masses may be put into oscillations by a suitable actuator. Coriolis acceleration acts on proof masses in opposite directions along the Y axis and generates torque around Z axis which is then transferred to the frame 34. The frame 34 is therefore responsive to the Coriolis acceleration. The motion of the frame 34 may be sensed by an appropriate transducer.

The angular velocity sensors shown in FIG. 1A may be rotated 90 degrees such that its input axis becomes X axis. As shown in FIG. 1B, if X angular velocity sensor 10, and Y angular velocity sensor 20 are mounted on the same substrate, the embodiment becomes a X-Y angular velocity sensor.

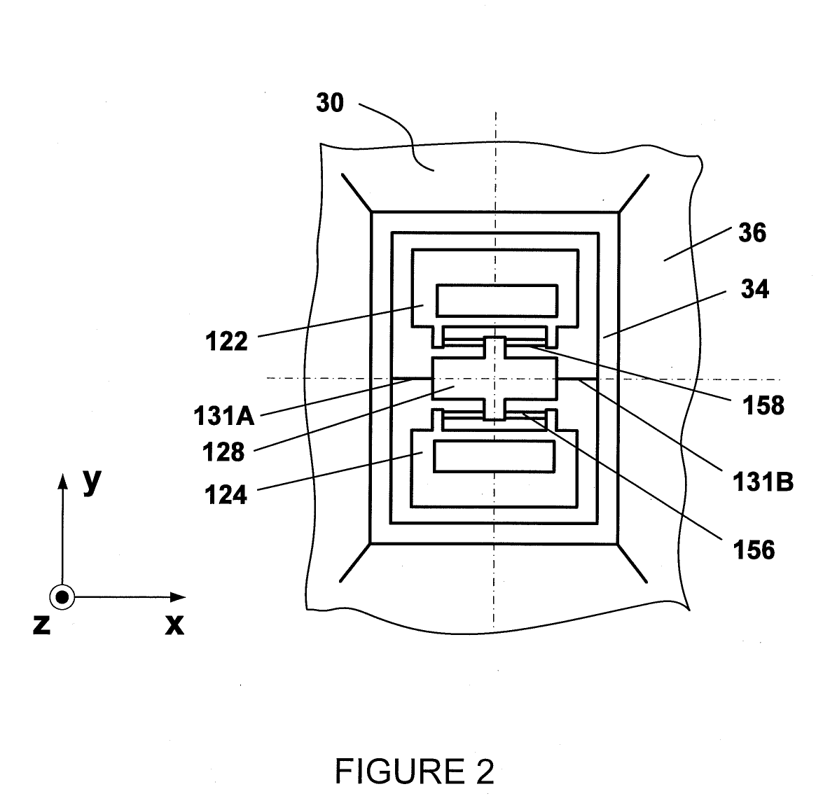

FIG. 2 includes a Z axis gyroscope 30 comprising base 36, sensing frame 34, first proof mass 122, second proof mass 124. This axis gyroscope is described, for example, in U.S. patent Ser. No. 11/935,357 entitled “Integrated MEMs Tuning Fork Vibrating Z-Axis Rate Sensor”. Proof masses are oscillated in-plane in anti-phase fashion by a appropriate actuator. Proof mass 122, proof mass 124, transmission mass 128, spring 131A-131B, spring 156 and spring 158 form linkages that allow the Coriolis acceleration to act on oscillated proof masses which are then transferred to the frame 34. The frame 34 is therefore responsive to the Coriolis acceleration. The motion of the frame may be sensed by an appropriate transducer.

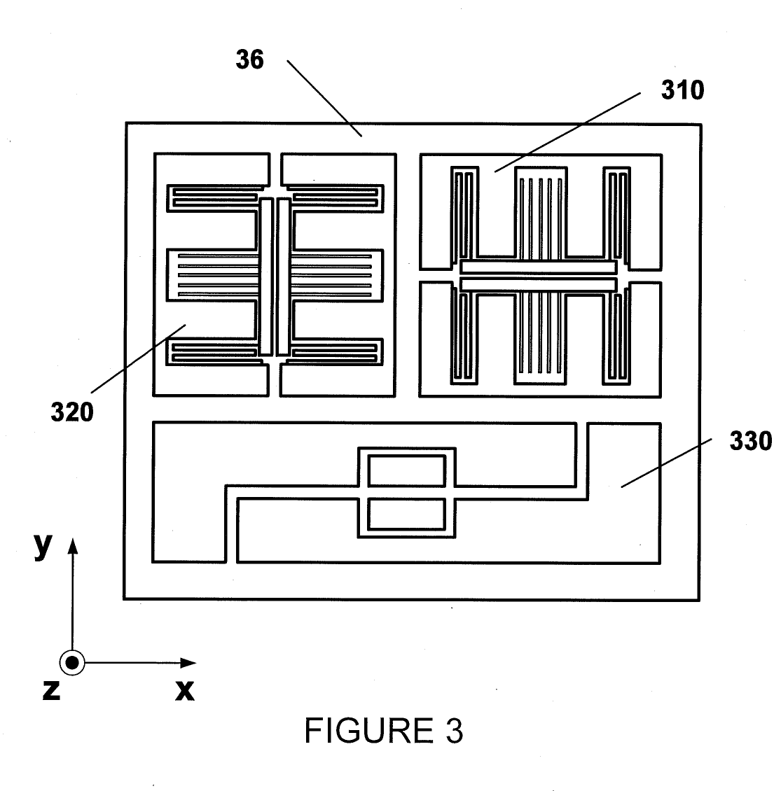

A triple axis accelerometer is shown in FIG. 3. It may comprise the first sensor 310 for detecting linear acceleration along X axis, second sensor 320 for detecting linear acceleration along Y axis and third sensor 330 for detecting linear acceleration along Z axis. Three linear acceleration sensors 310, 320 and 330 are flexibly suspended to the base 36 and share the same substrate. The X linear acceleration sensor 310 comprises one or two proof masses responsive to the acceleration along X axis. The Y linear acceleration sensor 320 comprises one or two proof masses responsive to the acceleration along Y axis. The Z linear acceleration sensor 330 comprises one or two proof masses responsive to the acceleration along Z axis. The motion of proof masses of each of the linear acceleration sensors may be detected by appropriate transducer.

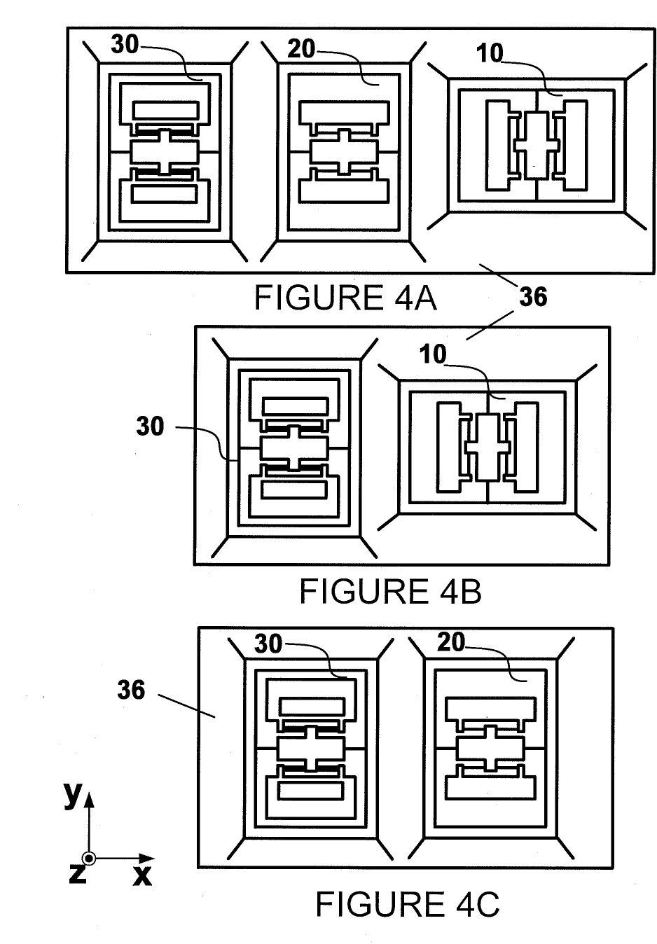

In one embodiment, two in-plane angular velocity sensors shown in FIG. 1B may be combined with out-of-plane angular velocity sensor shown in FIG. 2. The resulting three degree-of-freedom angular velocity sensor is shown in FIG. 4A. All three individual angular sensors have the same sensing scheme. The sensing scheme comprises substantially similar frame for all three angular velocity sensors. Coriolis acceleration generates Coriolis torque which in turn moves the frame. In this way the frame is responsive to the Coriolis acceleration. Proof masses of X axis angular velocity sensor and Y axis angular velocity sensor are oscillated out-of-plane in anti-phase fashion. Input axes are parallel to the plane and peropendicular to each other. Coriolis acceleration therefore acts in the plane. Direction of input axis will depend on the in plane orientation of the proof masses with respect to the linkage. On the other hand, proof masses of the Z-axis angular velocity sensor are oscillated in plane. If input axis is normal to the plane, Coriolis acceleration is generated in the plane similarly as for X and Y sensors. Coriolis acceleration for all three sensors is therefore generated within the plane causing substantially similar motion of the frame. The same sensing methodology allows for the use of similar electronic circuitry for all three axis. In addition, many electronic circuits can be shared between three sensors. The same sensing methodology simplifies a development cycle and production testing. Moreover, building of three axis angular velocity sensor on the same substrate provides well defined input axes. This way, the misalignment of the three input axes is significantly reduced when compared to the individual sensors which have to be mounted on the printed circuit board mounted within a package, or mounted on a die.

In another embodiment of the present invention, three DOF angular velocity sensor shown in FIG. 4A may be reduced to two DOF sensors by either removing Z axis sensor, as shown in FIG. 1B, or one of either the X or Y axis sensors. If Y axis sensor is removed, the resulting two DOF sensor is XZ as shown in FIG. 4B. If X axis sensor is removed, the resulting two DOF sensor is YZ as shown in FIG. 4C. XY, XZ and YZ angular velocity sensors retain the same set of advantages over the plurality of individual sensors as XYZ sensor described above.

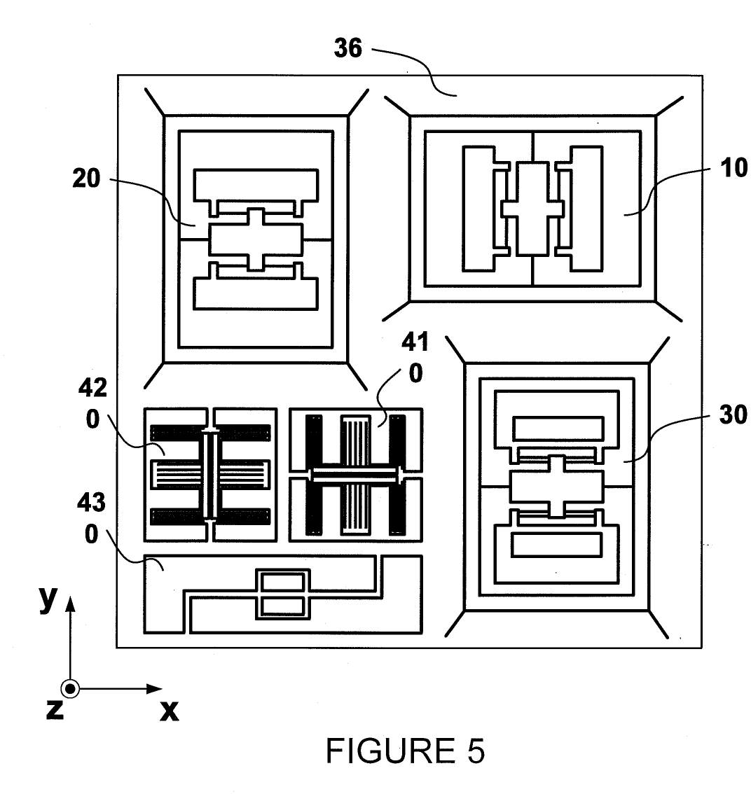

In another embodiment and referring to FIG. 5, three linear acceleration sensors, 410, 420 and 430, shown in FIG. 3, may be built on the same substrate together with angular velocity sensors 10, 20, and 30, shown in FIG. 4A. Integrating sensors together ensures that input axes of angular velocity sensors and linear acceleration sensors may be aligned substantially accurately, therefore mitigating cross-sensitivity problem.

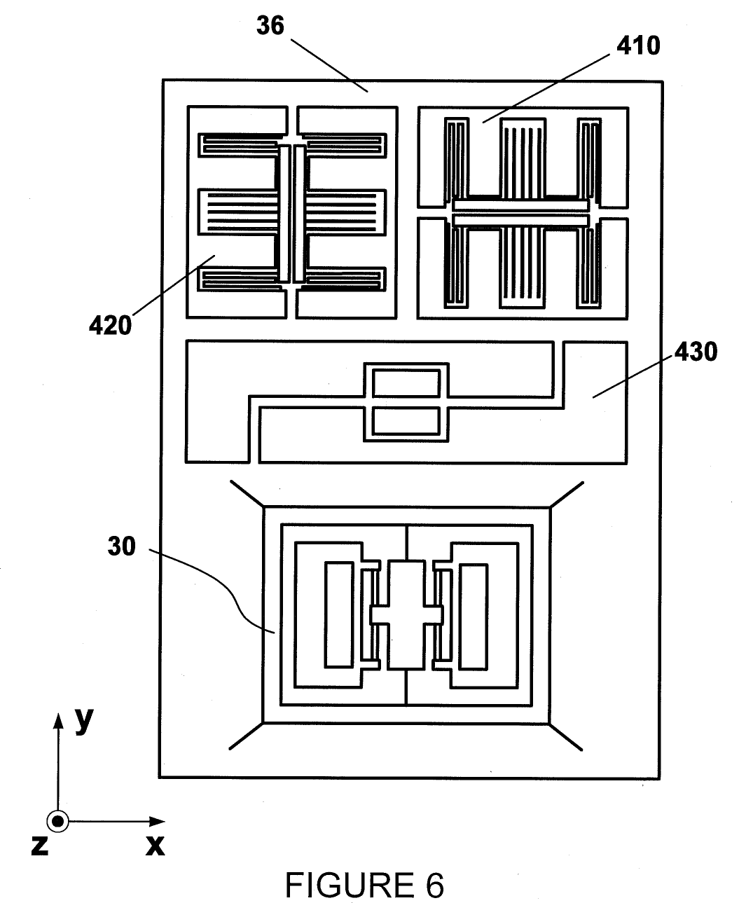

Further, in another embodiment shown in FIG. 6, three linear accelerometers, 410, 420 and 430, shown in FIG. 3, may be built on the same substrate together with angular velocity sensor 30 shown in FIG. 2.

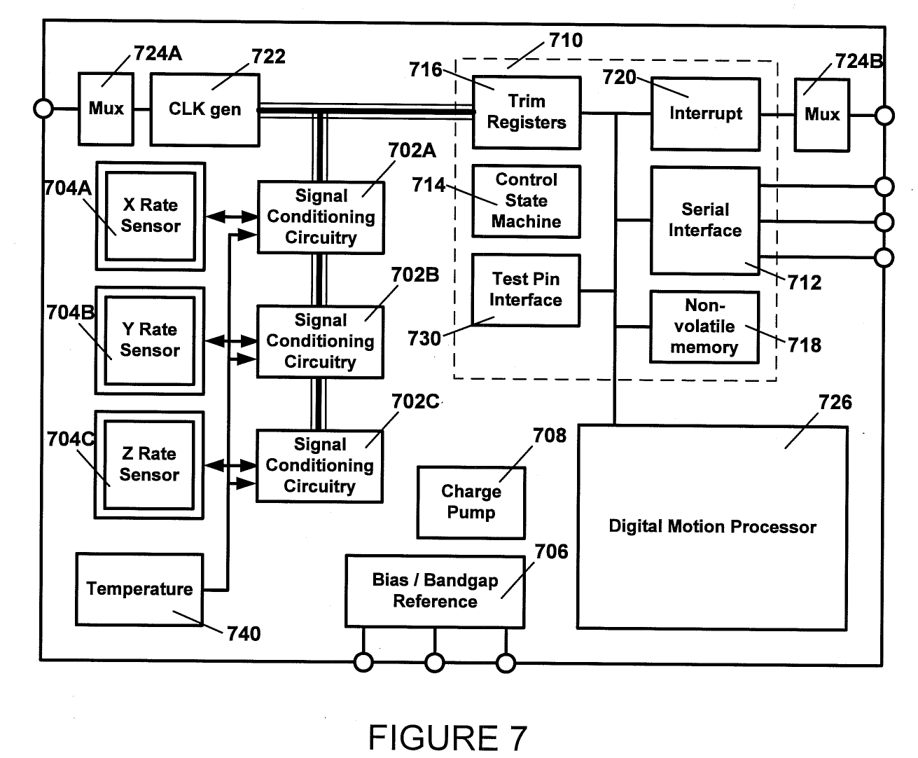

A typical ASIC 700 for three DOF angular velocity sensor, may be given as shown in FIG. 7. Signal conditioning circuitry 702A-702C, including pick-up, demodulator, amplifiers and baseband amplifiers, are sensor-specific and each individual sensor comprises such circuits. Three angular velocity sensors 704A-704C may be designed such that signal conditioning circuitry can be the same for all of them. Such a feature reduces development time and consequently, price of a product. A significant portion of the ASIC may, however, be shared among all three individual sensors. Bandgap and bias circuitry 706 typically contributes a large percentage of the ASIC area. However, they may be shared among the plurality of the inertial sensors. Furthermore, a charge pump 708 provides high voltage for actuating the drive portion of the sensors. The charge pump 708 is even more area-consuming than reference circuitry. Another circuit shared by the plurality of sensors may be temperature sensor 740. Sharing of the common ASIC blocks between a plurality of sensors 704A-704C substantially reduces product size. Furthermore, the ASIC may comprise a digital circuitry 710 for testing and sensor output. The digital circuitry may comprise serial interface 712, control state machine 714, various registers 716, non-volatile memory 718, interrupt block 720, clock generation blocks 722, various multiplexers 724A-724B and test pin interface 730. This portion of the ASIC may also be shared among plurality of sensors, reducing the size of the die even further. The disclosure is not limited mentioned blocks and there may be other integrated circuit blocks that are shared between a plurality of sensors.

Another portion of ASIC may comprise a digital motion processor 726. The function of the digital motion processor comprises processing and fusion of single-axis measurements and providing a suitable output that can be directly used at higher, i.e. application, level. Although the digital motion processor 726 adds more space to the sensing assembly, it takes over the processing load from the main application processor. As such, the inertial sensing assembly with digital motion processor enables opening of new markets such as handset or gaming markets. Without having a plurality of the sensors 704A-704C on the common substrate, there would be no point of processing measured data on that very substrate.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. An inertial sensor assembly comprising:
a substrate parallel to the plane;
at least one angular velocity sensor comprising a pair of proof masses that are oscillated in anti-phase fashion along an axis normal to the plane; said angular velocity sensor comprising a sensing frame responsive to the angular velocity of the substrate around the first axis parallel to the plane; said sensing frame moving in-plane in response to said angular velocity; a transducer for sensing motion of said sensing frame;
at least one angular velocity sensor comprising a pair of proof masses that are oscillated in anti-phase fashion along an axis parallel to the plane; said angular velocity sensor comprising a sensing frame responsive to the angular velocity of the substrate around the axis normal to the plane; said sensing frame moving in-plane in response to said angular velocity; a transducer for sensing motion of said sensing frame;

2. The inertial sensor assembly from claim 1 further comprising at least one angular velocity sensor comprising a pair of proof masses that are oscillated in anti-phase fashion out-of-plane along the axis normal to the plane; said angular velocity sensor further comprising a sensing frame responsive to the angular velocity of the substrate around the second axis parallel to the plane, said second axis being perpendicular to the first axis; said sensing frame moving in-plane in response to said angular velocity; a transducer for sensing motion of said sensing frame;

3. The inertial sensor assembly from claim 2 further comprising at least one mass sensitive to linear acceleration; a transducer for sensing motion of said mass;

4. The inertial sensor assembly from claim 1 further comprising at least one mass sensitive to linear acceleration; a transducer for sensing motion of said mass;

5. An inertial sensor assembly comprising:
a substrate parallel to the plane;
at least one angular velocity sensor comprising a pair of proof masses that are oscillated in anti-phase fashion along the axis parallel to the plane; said angular velocity sensor further comprising a sensing frame responsive to the angular velocity of the substrate around the axis normal to the plane; said sensing frame moving in-plane in response to said angular velocity; a transducer for sensing motion of said sensing frame; and
at least one mass sensitive to linear acceleration; a transducer for sensing motion of said mass;

6. An inertial sensor assembly comprising:
a substrate parallel to the plane;
at least one angular velocity sensor comprising a pair proof masses that are oscillated in anti-phase fashion along an axis normal to the plane; said first angular velocity sensor further comprising a sensing frame responsive to the angular velocity of the substrate around the first axis parallel to the plane; said sensing frame moving in-plane in response to said angular velocity; a transducer for sensing motion of said sensing frame; and
at least one mass sensitive to linear acceleration; a transducer for sensing motion of said mass.
